(19) United States
(12) Patent Application Publication
(10) Pub. No.: US 2008/0267298 A1
(43) Pub. Date: Oct. 30, 2008

(54) MOVING IMAGE DECODING DEVICE, BROADCASTING RECEPTION DEVICE, AND MOVING IMAGE DECODING METHOD

(76) Inventors: Michiyo Morimoto, Fuchu-shi (JP); Hiroshi Yonekubo, Tokyo (JP); Masakazu Suzuki, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/046,569

(22) Filed: Mar. 12, 2008

(30) Foreign Application Priority Data
Apr. 27, 2007 (JP) 2007-119476

(51) Int. Cl. H04N 7/26

(52) U.S. Cl. 375/240.27; 375/E07.027

(57) ABSTRACT

According to one embodiment, there is provided a moving image decoding device including a detecting section which detects an error of a macro block from a stream signal composed of a plurality of slices having a plurality of macro blocks, a control section which, when a skip macro block is present in a slice including the macro block where the detecting section detects an error and a CBP value of the macro block in this slice exceeds a threshold, discards macro blocks after the macro block where the CBP value exceeds the threshold, and a decoding section which conceals and decodes the stream signal where the macro block row including the error is discarded by the control section so as to output a moving image signal.

### CROSS-REFERENCE TO RELATED APPLICATION

This application is based upon and claims the benefit of priority from Japanese Patent Application No. 2007-119476, filed Apr. 27, 2007, the entire contents of which are incorporated herein by reference.

### BACKGROUND

1. Field

One embodiment of the present invention relates to a moving image decoding device, a broadcasting reception device and a moving image decoding method which are provided to a terminal which receives digital terrestrial broadcasting and mobile broadcasting.

2. Description of the Related Art

In recent years, coding and decoding techniques for an image medium are developing increasingly. This is because qualities of moving images and audio are heightened and thus the amount of information increases, or wired or wireless networks develop and thus the demand for transmitting image information via the networks increases.

A lot of moving image compressing techniques which treat such moving images are known and are utilized in various digital devices. Most of the moving image compressing techniques use stream signals composed of a plurality of slices (SL) having a plurality of macro blocks (MB).

In such moving image compressing techniques, when receiving terminals are portable terminals or mobile terminals represented by in-vehicle terminals, the receiving terminals are moved, and thus it is not expected that stream data are received in an always stable radio wave environment. Particularly in an environment in which receiving terminals are shielded by buildings, errors are mixed in stream data at high frequency. Therefore, an error resilient function is essential in moving image decoding devices installed in the mobile terminals, and various examinations therefore are being carried out.

In Patent Document 1 (Jpn. Pat. Appln. KOKAI Publication No. 2006-295569), when a notably large mb_skip_run in which, control data representing a length of a skip run inserted into a head of each macro block, namely, the number of macro blocks to be skipped (mb_skip_run) exceeds an upper limit length arbitrarily set according to a lateral size of an image, is detected, this is regarded as a macro block with which an error is mixed. Decoding information of macro blocks after this macro block is discarded, so that a misinterpretation block is shortened.

In the conventional technique disclosed in Patent Document 1, however, when mb_skip_run does not exceed the upper limit length, namely, the number of CBPs (Coded Block Pattern) is suddenly large although a picture has less difference information, the number of CBPs is not checked. Therefore, since a moving image signal having an error, in which the number of CBPs is suddenly large, has a long misinterpretation block, a defect such that a part of a screen is displayed with abnormal color occurs in a one-segment mobile broadcasting receiver.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram illustrating one example of a constitution of a decoding circuit according to one embodiment of the present invention;

FIG. 2 is a flow chart illustrating one example of a macro block decoding process in the decoding circuit according to one embodiment of the present invention;

FIG. 3 is a flow chart illustrating another example of the macro block decoding process in the decoding circuit according to one embodiment of the present invention;

FIG. 4 is an explanatory diagram illustrating one example of a data structure of one slice according to one embodiment of the present invention;

FIG. 5 is an explanatory diagram illustrating one example of a place where data discarding starts in one slice in a picture subject to the decoding process by means of the decoding circuit according to one embodiment of the present invention;

FIG. 6 is an explanatory diagram illustrating one example of a macro block subject to the decoding process by means of the decoding circuit according to one embodiment of the present invention;

FIG. 7 is an explanatory diagram illustrating another example of the place where data discarding starts in one slice in a picture subject to the decoding process by means of the decoding circuit according to one embodiment of the present invention;

FIG. 8 is an outline view illustrating one example of a mobile device using the decoding circuit according to one embodiment of the present invention; and

FIG. 9 is a block diagram illustrating one example of a constitution of the mobile device using the decoding circuit according to one embodiment of the present invention.

### DETAILED DESCRIPTION

Various embodiments according to the invention will be described hereinafter with reference to the accompanying drawings. In general, according to one embodiment of the invention, a moving image decoding device comprising: a detecting section which detects an error of a macro block from a stream signal composed of a plurality of slices having a plurality of macro blocks; a control section which, when a skip macro block is present in a slice including the macro block where the detecting section detects an error and a CBP value of the macro block in this slice exceeds a threshold, discards macro blocks after the macro block where the CBP value exceeds the threshold; and a decoding section which conceals and decodes the stream signal where the macro block row including the error is discarded by the control section so as to output a moving image signal.

An embodiment of the present invention will be described in detail below with reference to the drawings.

<One Example of Constitution of Moving Image Decoding Device according to One Embodiment of the Present Invention>

A moving image decoding device according to one embodiment of the present invention has a decoding control section 11 which has a function for determining the number of CBPs (Coded Block Pattern) of a macro block as described later. As a result, when the CBP value suddenly becomes large, the macro block is estimated to include an error and is discarded and concealed, so that deterioration in image quality due to misinterpretation of a macro block is reduced.

In the following description about the moving image decoding device according to one embodiment of the present invention, a method called ITU-T recommended H.264/AVC (Advanced Video Coding) will be described as an example of the moving image decoding method. However, the moving image decoding device and method of the present invention are not limited to H.264/AVC, and the present invention can be applied to any moving image decoding method using macro blocks similarly.

(Constitution)

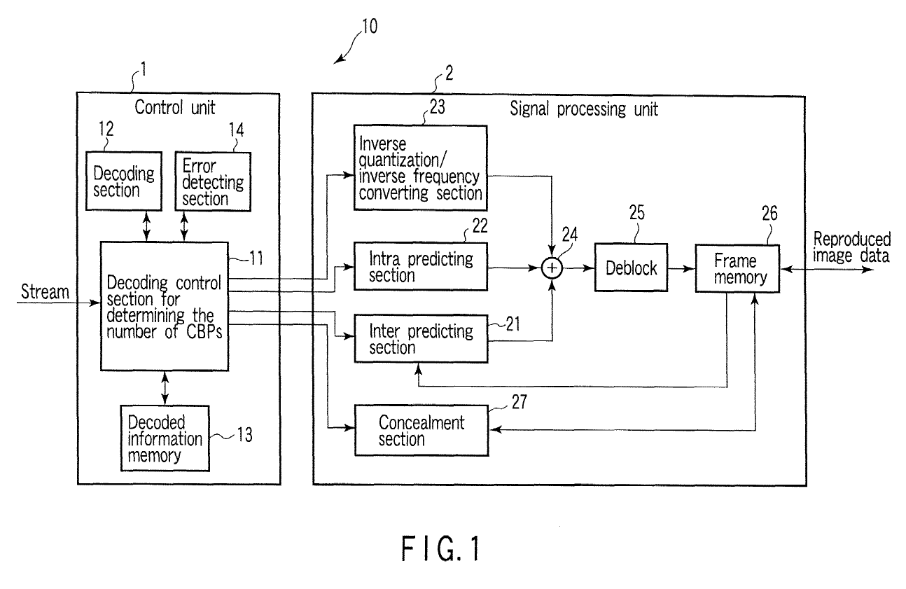

One example of the constitution of the moving image decoding device according to one embodiment of the present invention will be described with reference to the drawings. FIG. 1 is a functional block diagram illustrating the moving image decoding device according to one embodiment of the present invention. The moving image decoding device in this embodiment includes a control unit 1 and a signal processing unit 2. The control unit 1 is composed mainly of a microprocessor, and includes a decoding control section 11, a decoding section 12, a decoded information memory 13 and an error detecting section 14. The decoding control section 11 determines the number of CBPs (Coded Block Pattern). The decoding control section 11, the decoding section 12 and the error detecting section 14 are realized by running a program by means of a microprocessor as one example. The decoded information memory 13 is composed of a RAM (Random Access Memory).

The decoding section 12 decodes stream data transmitted from the decoding control section 11 per macro block, and returns the decoded information per syntax to the decoding control section 11. The decoded information memory 13 successively stores the decoded information of each macro block acquired by the decoding section 12 under the control of the decoding control section 11. The error detecting section 14 determines whether an error is present in the decoded information every time the decoded information of syntax is supplied from the decoding control section 11, and returns the determined result to the decoding control section 11 which determines the number of CBPs.

The decoding control section 11 which determines the number of CBPs captures stream data per macro block and allows the decoding section 12 to decode them, and allows the decoded information memory 13 to store the decoded information. When the decoding of one slice data is ended, each macro block stored in the decoded information memory 13 is supplied to any one of an inter predicting section 21, an intra predicting section 22 and an inverse quantization/inverse frequency converting section 23 in the signal processing unit 2, mentioned later, according to types. Image data are reproduced therein.

The decoding control section 11 which determines the number of CBPs gives the decoded information of syntax acquired from the decoding section 12 to the error detecting section 14, and a determination is made whether an error is present therein. The decoding control section 11 specifies a macro block where the error is detected based on the determined result. As a result of the determination, when an error is detected in a certain macro block, the decoded information of macro blocks preceding this macro block is successively read from the decoded information memory 13. A determination is made whether decoded information including syntax which does not conform to a rule is present, and a macro block with which an error is mixed is estimated based on the determined result.

The decoding control section 11 which determines the number of CBPs discards the decoded information of the macro blocks after the macro block including the error from the decoded information memory 13 based on the estimated result. A concealment section 27 of the signal processing unit 2, mentioned later, is instructed to restore the discarded macro block.

On the other hand, the signal processing unit 2 has the inter predicting section 21, the intra predicting section 22, the inverse quantization/inverse frequency converting section 23, a data synthesizing section 24, a deblock section 25, a frame memory 26, and the concealment section 27. The inter predicting section 21, the intra predicting section 22, the inverse quantization/inverse frequency converting section 23, the data synthesizing section 24, the deblock section 25 and the concealment section 27 are realized by a signal process by DSP (Digital Signal Processor).

The frame memory 26 is composed of a RAM (Random Access Memory), and reproduced frame image data is accumulated therein as reference image data.

The inter predicting section 21 calculates a predicting signal of an inter macro block using the reference image data accumulated in the frame memory 26. The intra predicting section 22 calculates a predicting signal of an intra macro block using reference pixels of an on-decoding frame.

The inverse quantization/inverse frequency converting section 23 executes an inverse quantization/inverse frequency converting process on an input macro block so as to calculate a residual signal.

The data synthesizing section 24 synthesizes the signals calculated by the inter predicting section 21, the intra predicting section 22 and the inverse quantization/inverse frequency converting section 23 so as to reproduce a macro block.

The deblock section 25 executes a deblocking filter process suitably on the macro block reproduced by the data synthesizing section 24, so as to remove a block distortion generated at the time of coding an image.

The concealment section 27 conceals information missed due to an error, and restores image data of a missing macro block based on related image data of another macro block according to the instruction from the decoding control section 11 which determines the number of CBPs. As the related information to be used for the concealment process, image data of a macro block positioned around a macro block to be concealed, or image data of a macro block on the same positions as frames after and before the frame to be concealed, is used.

(Decoding Control Using the Number of CBPs)

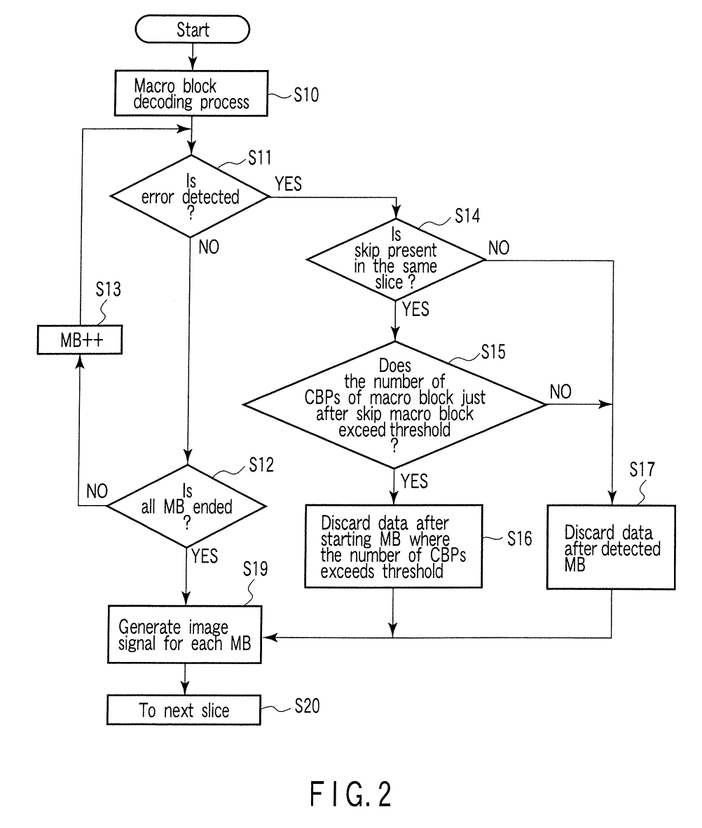

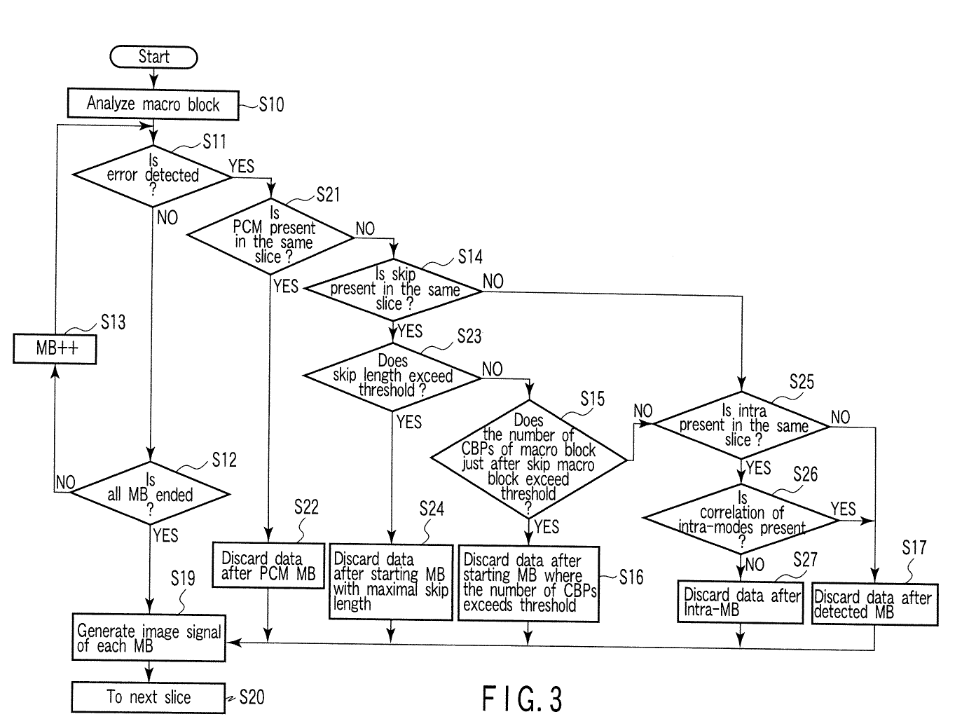

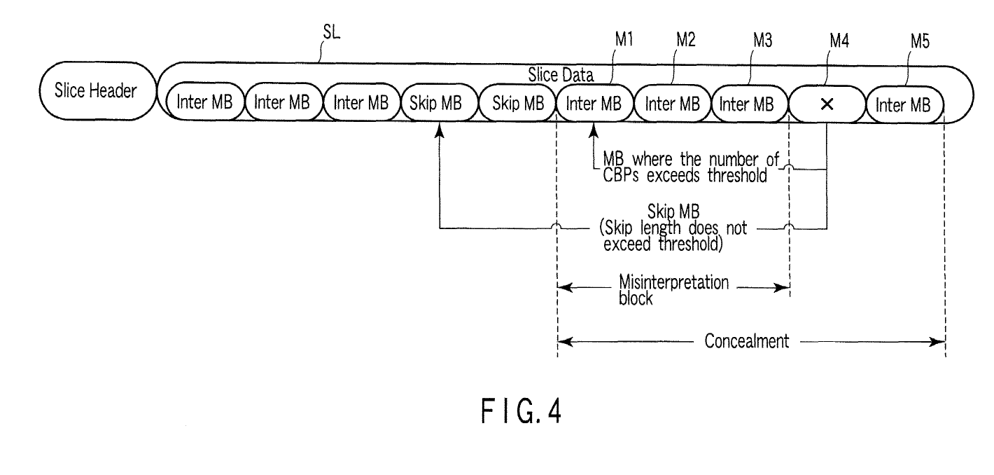

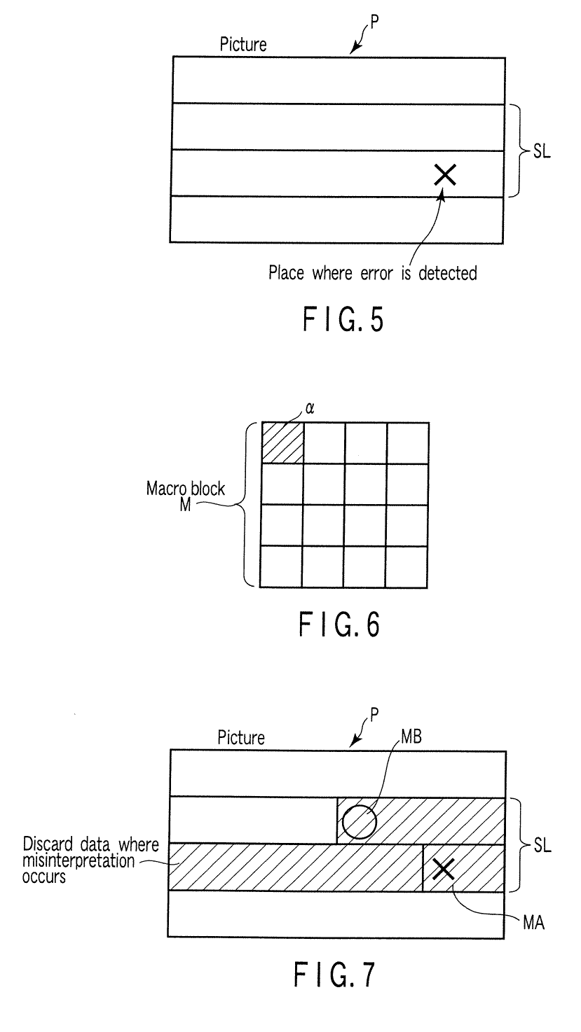

A decoding process for determining the number of CBPs in the moving image decoding device 10 having the above constitution will be described below with reference to the flow chart in FIG. 2 showing the control procedure of the decoding control section 11 for determining the number of CBPs. FIG. 2 is a flow chart illustrating one example of a macro block decoding process in a decoding circuit according to one embodiment of the present invention. FIG. 3 is a flow chart illustrating another example of the macro block decoding process in the decoding circuit according to one embodiment of the present invention. FIG. 4 is an explanatory diagram illustrating one example of a data structure of one slice according to one embodiment of the present invention. FIG. 5 is an explanatory diagram illustrating one example of a place where data discarding starts in one slice in a picture to be decoded by means of the decoding circuit according to one embodiment of the present invention. FIG. 6 is an explanatory diagram illustrating one example of a macro block to be decoded by means of the decoding circuit according to one embodiment of the present invention. FIG. 7 is an explanatory diagram illustrating one example of a starting place of data discarding in one slice of a picture to be decoded by means of the decoding circuit according to one embodiment of the present invention.

As shown in the flow chart of FIG. 2, in the moving image decoding device 10 of the present invention, when stream data is firstly input into the control unit 1, the decoding control section 11 which determines the number of CBPs captures the stream data per macro block and allows the decoding section 12 to decode them. The decoded information is stored in the decoded information memory 13 (step S10).

At this time, a stream signal composing one picture screen P is divided into a plurality of slices SL as shown in FIG. 5 as one embodiment so as to be transmitted. As shown in FIG. 6, one macro block M is divided into 16 blocks, for example, and only one of the 16 blocks has CBP data α.

When a skip macro block is present in one frame, a change in a moving image is very small. For this reason, the respective blocks of the macro blocks M in the slice SL seldom have many CBP data α, and thus have 0 or several data. Therefore, a threshold is set to “6”, and the number of blocks having CBP data in each macro block M is counted, and the counted number is compared with the threshold so that abnormality can be detected.

That is to say, since the number of blocks having CBP data in the macro block M in the slice SL is “3” and the threshold is “6” or less, a determination is made as normal, or since the number of blocks having CBP data in the macro block M in the slice SL is “9” and the threshold is “6” or more, a determination is made that an error is present.

The decoded information of the syntax acquired by the decoding section 12 is supplied to the error detecting section 14, and the error detecting section 14 determines whether an error is present (step S11). The error detecting section 14 reads decoded information of preceding macro blocks from the decoded information memory 13, so as to determine whether the decoded information which includes syntax not conforming to the rule is present. When an error is not detected in the syntax as a result of the determination, the process goes from step S11 to step S12, so that a determination is made whether the decoding of all the macro blocks in one slide data is ended. When non-decoded macro block remains, a next macro block is selected at step S13, and decoding is controlled. Thereafter, the decoding control is repeated until the decoding process on all the macro blocks in one slice data is completed.

When the decoding control for all the macro blocks in one slice data is completed, the signal processing unit 2 generates an image signal of a macro block (step S19). That is to say, the decoding control section 11 which determines the number of CBPs successively reads macro blocks in one slice data stored in the decoded information memory 13, and supplies the macro blocks to the inter predicting section 21, the intra predicting section 22 or the inverse quantization/inverse frequency converting section 23 according to types.

As a result, the inter predicting section 21, the intra predicting section 22 and the inverse quantization/inverse frequency converting section 23 calculate predicting signals and residual signals, and the calculated predicting signals and residual signals are synthesized by the data synthesizing section 24 so as to become reproducing image data of the macro block. The deblock section 25 executes the deblocking filter process on the reproducing image data, and thus a block distortion which occurs at the time of coding the image is removed. The deblocked and filtered reproducing image data is accumulated as reference image data in the frame memory 26.

At step S11, the macro block decoding process is executed, and when the error detecting section 14 determines that decoded information of preceding macro blocks includes syntax non-conforming to the rule and that an error is present, generally concealment is carried out starting from the macro block where the error is detected. However, actually data of macro blocks preceding the macro block where the error is detected frequently has an error, and a block which is misinterpreted is present while an error occurs in data and the error is detected.

The decoding control section 11 which determines the number of CBPs pays attention to the number of CBPs in a slice macro block so as to detect a macro block where an error is mixed.

That is to say, since the skip macro block is originally a macro block which is provided due to less difference information, the number of CBPs as a value showing the difference should be small (threshold or less). However, when data of a macro block is destroyed due to a noise in the process of communication, the number of CBPs becomes suddenly large in some cases.

In one embodiment of the present invention, attention is paid to the number of CBPs of a macro block just after the skip macro block which originally obtains a small value and the number of CBPs is monitored. When the number of CBPs of the macro block just after the skip macro block exceeds a predetermined value, that macro block is regarded as abnormal, and the macro blocks after that macro block are discarded.

That is to say, as shown in FIG. 4, the decoding control section 11 which determines the number of CBPs searches the macro blocks preceding a macro block M4 where an error in slice SL is detected for a skip macro block (step S14). When the skip macro block is present, as shown in FIG. 4, the decoding control section 11 determines whether the number of CBPs in a macro block M1 just after the skip macro block exceeds a threshold (step S15).

That is to say, since particularly the macro block just after the skip macro block normally includes less differential information, the number of CBPs becomes small. For this reason, the number of CBPs is compared with a constant threshold, so that abnormality can be detected.

When the number of CBPs of the macro block just after the skip macro block does not exceed the threshold, data of macro blocks after the macro block M4 where an error is detected are discarded (step S17).

However, when the decoding control section 11 determines that the number of CBPs of the macro block M1 just after the skip macro block in FIG. 4 exceeds the threshold (step S15), macro blocks M2, M3, M4 and M5 after the macro block M1 where the number of CBPs exceeds the threshold are discarded (step S16). In FIG. 7, in the slice SL in the picture P, this is shown as a macro block MA where an error is firstly detected, and a macro block MB detected later where the number of CBPs exceeds the threshold.

As a result, the error detecting section 14 not only detects an error based on syntax but also determines whether the number of CBPs exceeds an arbitrarily set threshold such as an average value in decoded macro blocks, so that a misinterpretation block can be shortened. Therefore, the moving image decoding device which further reduces deterioration in image quality due to misinterpretation can be provided.

In general, the number of CBPs is approximately uniform in macro blocks in a slice. Therefore, the number of CBPs is detected not only for a macro block just after the skip macro block but also for the macro block just after the skip macro block and the following macro blocks or n-numbered macro blocks after the skip macro block in a slice including the skip macro block. The number of CBPs is compared with the predetermined threshold so as to be preferably determined. The macro blocks after the macro block where the number of CBPs exceeds the threshold are discarded so that the concealment process is executed.

Similarly, as to the slice including the skip macro block, the number of CBPs is detected not only for the macro block just after the skip macro block but also for all the macro blocks in the slice, and a determination is made in such a manner that the number of CBPs is compared with the prepared threshold. Among all the macro blocks in the slice, the macro blocks after the macro block where the number of CBPs exceeds the threshold are discarded so that the concealment process is preferably executed.

(The Other Decoding Process)

Besides “to detect an error based on the number of CBPs of a macro block in a slice including a skip macro block”, error detecting methods which are considered to be effectively executed simultaneously will be described with reference to the flow chart of FIG. 3.

That is to say, the concrete error detecting method is as follows:

When “a PCM macro block is present in one slice”, this situation is detected as an error; and

When “a skip macro block where a skip length exceeds a threshold is present in one slice”, this situation is detected as an error.

An uncompressed macro block such as a PCM macro block (Pulse Code Modulation Macro Block) is hardly considered to be present in stream data. Therefore, when a PCM macro block as an uncompressed macro block is found in stream data, this macro block can be regarded as a macro block including an error.

In H.264, control data (mb_skip_run) representing a length of a skip run, namely, the number of macro blocks to be skipped is inserted at a head of each macro block. The skip run length is generally determined by a lateral size or the like of an image. For this reason, when a very large mb_skip_run which exceeds an upper limit length arbitrarily set is detected, this block can be regarded as a macro block including an error. Decoding information of macro blocks after this macro block is discarded, so that a misinterpretation block can be shortened.

In H.264, intra-screen predicting modes are coded independently for a luma component and a chroma component. In general, the luma component is correlated with the chroma component, and their corresponding predicting modes are correlated with each other. Therefore, when an intra-frame predicting macro block in stream data where the predicting modes corresponding to the luma component and the chroma component are not correlated with each other is detected, this macro block can be regarded as a macro block including an error. Decoding information of macro blocks after this macro block is discarded, so that the misinterpretation block can be shortened.

That is to say, the moving image decoding device 10 of the present invention executes the decoding process on macro blocks in each slice as shown in the flow chart of FIG. 3. The description about steps S11 to S20 which are common with the flow chart of FIG. 2 is omitted.

Flow chart of FIG. 3 illustrates one example of the case where the above three error detecting methods are executed simultaneously with “detecting an error based on the number of CBPs in a macro block in a slice including a skip macro block” at step S15.

When an error is detected at step S11, the decoding control section 11 determines whether a PCM macro block is present in a slice including the error (step S21). When present, the decoding control section 11 discards data of the macro blocks after the PCM macro block in the slice, and the concealment process is executed (step S22).

When the decoding control section 11 determines that the skip macro block is present in the slice where the error is detected at step S14, the decoding control section 11 determines whether the length of the skip macro block exceeds the threshold (step S23). When the length of the skip macro block exceeds the threshold, data of macro blocks after the macro block as a starting point of the maximum skip length are discarded, and the concealment process is executed (step S24).

When the skip macro block is not present in the slice where the error is detected at step S14, the decoding control section 11 determines whether an intra-macro block is present in the slice (step S25). When the skip macro block is not present in the slice where the error is detected, the decoding control section 11 discards data of the macro blocks after the macro block where the error is detected (step S17).

However, when the decoding control section 11 determines at step S25 that the intra-macro block is present in the slice where the error is detected and the luma component is correlated with the chroma component, the process goes to step S17, so that data of the macro blocks after the macro block where the error is detected are discarded (step S17).

However, the decoding control section 11 determines at step S26 that the luma component is not correlated with the chroma component, it discards data of macro blocks after the intra-macro block (step S27).

As a result, besides “to detect an error based on the number of CBPs in a macro block in a slice including a skip macro block”, the cases where “a PCM macro block is present in the slice”, “a skip macro block where the skip length exceeds the threshold is present in the slice”, and “an intra-macro block, where the intra-predicting modes of predicting information of the luma component and the chroma component in the intra-macro block are not correlated with each other, is present in the slice” can be determined as errors. As a result, in many cases, the moving image decoding device which can reduce the deterioration in image quality due to the data misinterpretation of the macro lock can be provided.

<Mobile Communication Device Using the Moving Image Decoding Device of the Present Invention>

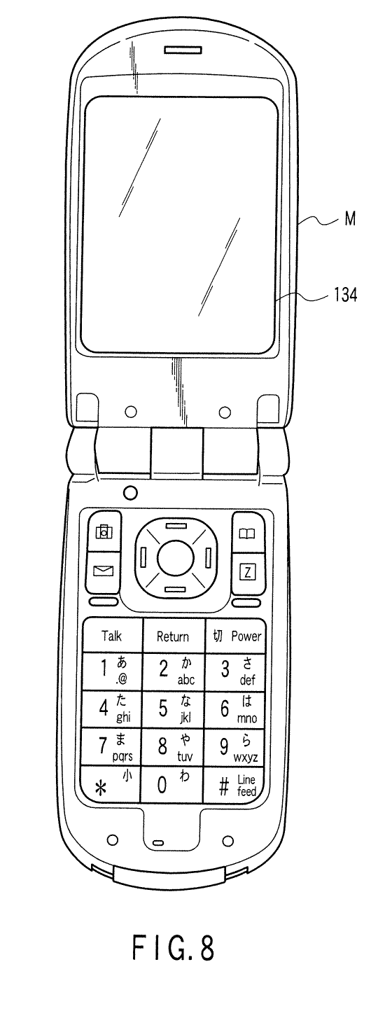

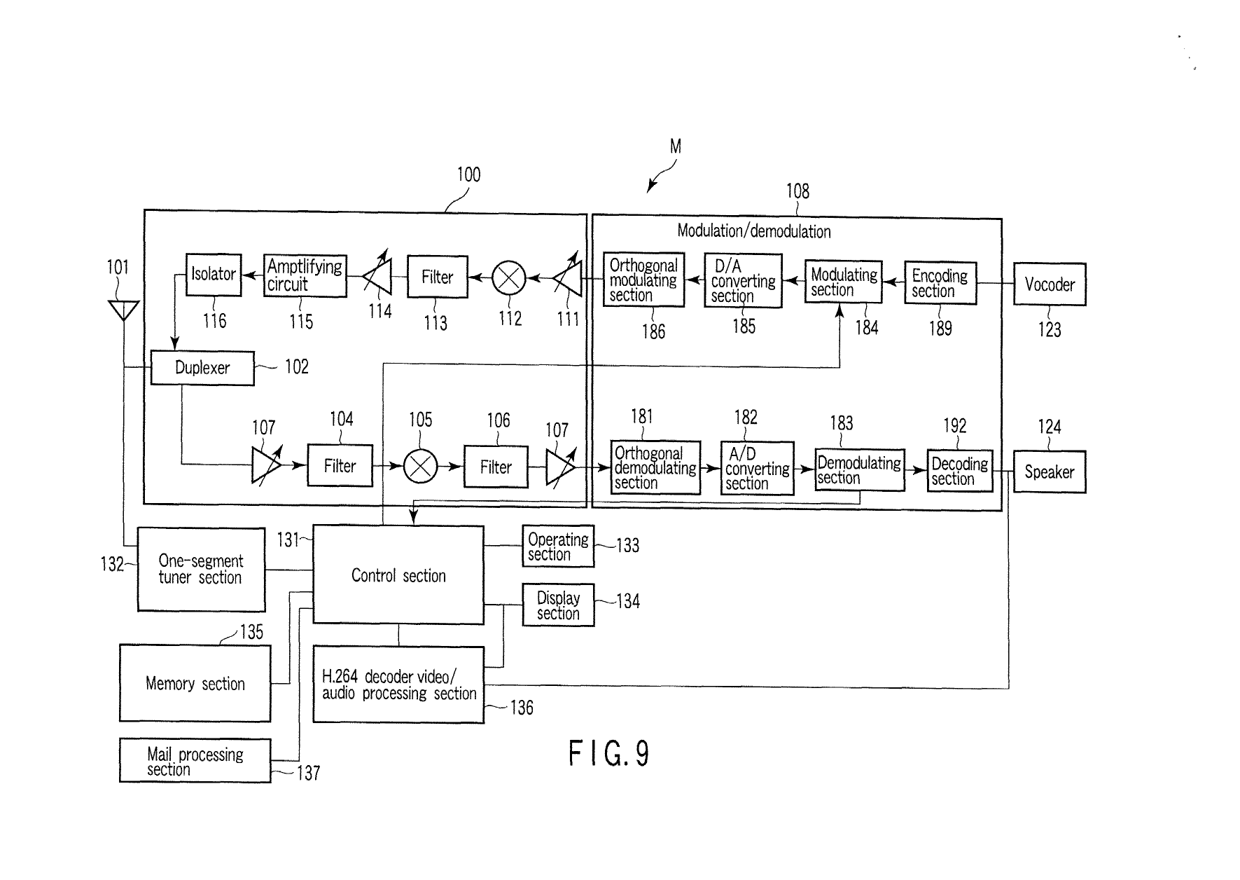

One example of a mobile communication device to which the moving image decoding device 10 of the present invention is applied will be described below with reference to FIGS. 8 and 9. FIG. 8 is an outline view illustrating one example of a mobile device using a decoding circuit according to one embodiment of the present invention. FIG. 9 is a block diagram illustrating one example of a constitution of the mobile device using the decoding circuit.

The mobile communication device (portable telephone device) M has an outline shown in FIG. 8 as an example. As shown in FIG. 9, the mobile communication device M has a communication section 100, an antenna 101, a duplexer 102, an RF receiving gain variable amplifier 103, an RF band limiting filter 104, a frequency converter 105, an IF band limiting filter 106, an IF receiving gain variable amplifier 107, a modulating/demodulating section 108, an IF transmitting gain variable amplifier 111, a frequency converter 112, an RF band limiting filter 113, an RF transmitting gain variable amplifier 114, an electric power amplifier 115, an isolator 116, a vocoder 123 and a speaker 124.

The mobile communication device M further has a control section 131, a one-segment tuner section 132, an operating section 133, a display section 134, a memory section 135, an H.264 decoder audio/video processing section 136, and a mail processing section 137. The control section 131 controls an entire operation. The one-segment tuner section 132 receives a one-segment television broadcasting signal. The operating section 133 has a plurality of switches. The display section 134 displays operating information and photograph images. The memory section 135 stores moving image contents and program reservation information. The moving image decoding device 10 according to one embodiment of the present invention is used as the H.264 decoder audio/video processing section 136. The control section 131 is connected with the one-segment tuner section 132, the operating section 133, the display section 134, the memory section 135, the H.264 decoder audio/video processing section 136, and the mail processing section 137. Outputs of the H.264 decoder audio/video processing section 136 are connected respectively with the display section 134 and the speaker 124.

The modulating/demodulating section 108 is composed of an orthogonal demodulating section 181, an A/D converting section 182, an information signal demodulating section 183, a decoding section 192, an encoding section 189, an information signal modulating section 184, a D/A converting section 185, and an orthogonal modulating section 186. The encoding section 189 encodes a signal from the vocoder 123. In this constitution, a signal which is orthogonally demodulated by the orthogonal demodulating section 181 is A/D converted by the A/D converting section 182, demodulated into an information signal by the information signal demodulating section 183, and decoded by the decoding section 192 so as to be output.

A receiving process in the mobile communication device M having such a constitution will be described. A forward link signal transmitted from a base station is received by the antenna 101, supplied to a receiver side circuit by the duplexer 102, and amplified or attenuated by the RF receiving gain variable amplifier 103. Unnecessary component of the forward link signal is filtered by the RF band limiting filter 104, and its frequency is converted from RF band into IF band by the frequency converter 105. An unnecessary component of the signal is filtered by the IF band limiting filter 106, the signal is amplified or attenuated by the IF receiving gain variable amplifier 107, and is input into the modulating/demodulating section 108.

The modulating/demodulating section 108 is composed of the orthogonal demodulating section 181, the A/D converting section 182, the information signal demodulating section 183, the information signal modulating section 184, the D/A converting section 185 and the orthogonal modulating section 186.

The encoding section 189 and the decoding section 192 preferably encode and decode a signal using common encryption key information, and prevent improper eavesdropping of communicated audio information by the encoding process. However, precisely the encryption key information for encoding on a mobile communicating section on the transmission side and key information of the decoding section 92 on the reception side may be common.

The receiving process in the mobile communication device M having this constitution will be described below. The following operation is performed according to display of operating information given from user's operation of the operating section 133 on the display section 134 and operation control of the control section 131. That is to say, a signal which has been orthogonally demodulated by the orthogonal demodulating section 181 is A/D converted by the A/D converting section 182, demodulated into an information signal by the information signal demodulating section 183, and decoded by the decoding section 192 so as to be output as an audio to the speaker 124.

The receiving process for a one-segment television broadcasting signal in the mobile communication device M will be described below. In the mobile communication device M, the one-segment tuner section 132 receives one-segment television broadcasting signals via the antenna 101. The one-segment tuner section 132 outputs one broadcasting signal selected according to channel information given from the operating section 133 to the control section 131.

The broadcasting signal supplied from the one-segment tuner section 132 is controlled by the H.264 decoder audio/video processing section 136 according to the above process so as to be decoded and converted into a reproducible video signal. The control section 131 preferably executes a scaling process and video processing so that the signal can be displayed on the display section 134 such as a liquid crystal screen.

The moving image decoding device and method of the present invention are preferably used for the process for reproducing a one-segment television signal of a portable mobile telephone as a mobile device.

According to the above embodiment, a person skilled in the art can realize the present invention, and further easily comes up with various modified examples of the embodiment. The present invention can be applied to various embodiments even without inventive ability. Therefore, the present invention covers a wide scope which is not inconsistent with the disclosed principle and new features, and thus the above embodiment is not restrictive.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A moving image decoding device comprising:
a detecting section which detects an error of a macro block from a stream signal composed of a plurality of slices having a plurality of macro blocks;
a control section which, when a skip macro block is present in a slice including the macro block where the detecting section detects an error and a CBP value of the macro block in this slice exceeds a threshold, discards macro blocks after the macro block where the CBP value exceeds the threshold; and
a decoding section which conceals and decodes the stream signal where the macro block row including the error is discarded by the control section so as to output a moving image signal.

2. The moving image decoding device according to claim 1, wherein when the skip macro block is present in the slice including the macro block where the detecting section detects the error and the CBP value of the macro block just after the skip macro block exceeds the threshold, the control section discards the respective macro blocks after the macro block where the CPB value exceeds the threshold.

3. The moving image decoding device according to claim 1, wherein a decoding process in the decoding section used in the moving image decoding device adopts H.264/AVC.

4. The moving image decoding device according to claim 1, wherein when the skip micro block is not present in the slice including the macro block where the detecting section detects the error, the control section discards the macro blocks after the macro block where the detecting section detects the error.

5. The moving image decoding device according to claim 1, wherein when a PCM macro block is present in the slice including the macro block where the detecting section detects the error, the control section discards macro blocks after the PCM macro block in the slice.

6. The moving image decoding device according to claim 1, wherein when the skip micro block where a skip length exceeds a threshold is present in the slice including the macro block where the detecting section detects the error, the control section discards macro blocks after the skip macro block having the maximum skip length.

7. The moving image decoding device according to claim 1, wherein when an intra-macro block is present in the slice including the macro block where the detecting section detects the error and a macro block where a correlation between intra-predicting modes of predicting information of a luma component and a chroma component in the intra-macro block is smaller than a threshold is detected, the control section discards macro blocks after the intra-macro block.

8. A broadcasting reception device comprising:
a tuner section which selects and receives a one-segment television broadcasting signal;
a decoding section which, when an error of a macro block is detected from a stream signal of the one-segment broadcasting signal received by the tuner section which is composed of a plurality of slices having a plurality of macro blocks, a skip macro block is present in a slice including the macro block having the detected error and a CBP value of the macro block in the slice exceeds a threshold, discards macro blocks after the macro block where the CBP value exceeds the threshold, and conceals and decodes the discarded stream signal so as to output a moving image signal; and
a display section which displays a moving image according to the moving image signal decoded by the decoding section on a screen.

9. The broadcasting reception device according to claim 8, wherein when the skip macro block is present in the slice including the macro block where the detecting section detects the error and the CBP value of the macro block just after the skip macro block exceeds the threshold, the control section discards macro blocks after the macro block where the CBP value exceeds the threshold.

10. A moving image decoding method comprising:
detecting an error of a macro block from a stream signal composed of a plurality of slices having a plurality of macro blocks;
when a skip macro block is present in a slice including the macro block and a CBP value of a macro block in the slice exceeds a threshold, discarding macro blocks after the macro block where the CBP value exceeds the threshold; and
concealing and decoding the stream signal where the macro block row with the error is discarded so as to output a moving image signal.
